(19) United States
(12) Patent Application Publication
(10) Pub. No.: US 2015/0022014 A1
(43) Pub. Date: Jan. 22, 2015

(54) Power Supply Device and Method for Detecting Presence of Foreign Object

(71) Applicant: FUNAI ELECTRIC CO., LTD., OSAKA (JP)

(72) Inventor: Hideki Tanabe, Osaka (JP)

(73) Assignee: FUNAI ELECTRIC CO., LTD., OSAKA (JP)

(21) Appl. No.: 14/325,520

(22) Filed: Jul. 8, 2014

(30) Foreign Application Priority Data
Jul. 22, 2013 (JP) 2013-151657

(51) Int. Cl. H01F 38/14

(52) U.S. Cl. CPC H01F 38/14
USPC 307/104

(57) ABSTRACT

The power supply device of the present invention is provided with: a power supply surface on which a power-supply object is placed; a plurality of electrodes arranged along the power supply surface; a capacitance-detecting unit for detecting the capacitance produced in each of the electrodes; and a control unit for scanning and driving the plurality of electrodes, identifying a capacitance distribution on the power supply surface on the basis of the capacitance produced in each of the electrodes as detected by the capacitance-detecting unit, determining the presence or absence of a foreign object on the power supply surface on the basis of the capacitance distribution, and performing a predetermined process. This makes it possible to detect with high accuracy the presence or absence of a foreign object on the power supply surface.

### INCORPORATION BY REFERENCE

This application is based upon and claims the benefit of priority from the corresponding Japanese Patent Application No. 2013-151657 filed on Jul. 22, 2013, the entire contents of which are incorporated herein by reference.

### FIELD OF THE INVENTION

The present invention relates to a power supply device for contactless power transmission, and to a method for detecting the presence of a foreign object.

### DESCRIPTION OF THE PRIOR ART

In recent years, systems for transmitting electric power from power supply devices to power-receiving devices (a “power-receiving device” is occasionally referred to as a “power-supply object” below in the specification and the claims) without contact (without the need to establish a physical electrical connection) have been developed. The method of providing a coil module to a power supply device and a power-receiving device and transmitting electric power by electromagnetic coupling is often used as a method for transmitting electric power without contact. Mobile phones, smart phones, tablet terminals, and various other electronic devices can receive electric power as power-receiving devices from power supply devices by the contactless transmission of electric power.

The contactless supplying of power is typically performed while a power-receiving device is placed on a power supply surface provided to a power supply device. The power supply efficiency decreases in cases in which there is an extraneous object (an “extraneous object” is occasionally referred to as a “foreign object” below in the specification and the claims) other than the power-receiving device on the power supply surface, and particularly in cases in which the extraneous object is positioned between the power supply surface and the power-receiving device. In cases in which the extraneous object is made of metal or another magnetic material, an eddy current is generated in the magnetic material by the magnetic field generated from the power supply device, and the extraneous object itself becomes abnormally heated.

Therefore, the contactless power supply system of JP-A 2012-213270 is provided with a power supply device and a power-receiving device to which electric power is supplied by the power supply device, has capacitance-producing electrodes arranged on both devices, and determines the presence or absence of a metal extraneous object on the basis of the capacitance between the two electrodes.

### SUMMARY OF THE INVENTION

In the contactless power supply system of JP-A 2012-213270, it is necessary to arrange capacitance-producing electrodes on both the power supply device and the power-receiving device. However, particularly as pertains to the power-receiving device, there is provided a wide range of power-receiving devices that lack capacitance-producing electrodes, and it is impossible to determine the presence or absence of a metal extraneous object in a case in which power is supplied to a power-receiving device that lacks a capacitance-producing electrode.

In view of the above problem, an object of the present invention is to provide a power supply device for detecting with high accuracy the presence or absence of a foreign object on the power supply surface, and a method for detecting a foreign object.

In order to achieve the above-mentioned object, the power supply device of the present invention is characterized in being provided with a power supply surface on which a power-supply object is placed, a plurality of electrodes arranged along the power supply surface, a capacitance-detecting unit for detecting the capacitance produced in each of the electrodes, and a control unit for scanning and driving the plurality of electrodes, identifying a capacitance distribution in the power supply surface on the basis of the capacitance produced in each of the electrodes as detected by the capacitance-detecting unit, determining the presence or absence of a foreign object on the power supply surface on the basis of the capacitance distribution, and performing a predetermined process.

In the power supply device configured as described above, it is preferable that the control unit determine the presence or absence of a foreign object on the power supply surface on the basis of the area and shape of a portion in which the value of the capacitance exceeds a predetermined value in the capacitance distribution in the power supply surface.

In the power supply device configured as described above, it is preferable that the control unit stop the supply of power to the power-supply object, as the predetermined process, in a case in which there is a foreign object on the power supply surface.

In the power supply device configured as described above, it is preferable that the control unit identify a position of a foreign object when the foreign object is on the power supply surface, and stop the supply of power to the power-supply object, as the predetermined process, in a case in which the foreign object is positioned in the vicinity of the power-supply object.

In the power supply device configured as described above, it is preferable that the control unit issue a warning about the presence of a foreign object, as the predetermined process, in a case in which the foreign object is on the power supply surface.

In the power supply device configured as described above, it is preferable that the control unit scan-drive the plurality of electrodes on the basis of information indicating a change in capacitance in at least one of the electrodes and identify a capacitance distribution in the power supply surface.

In the power supply device configured as described above, it is preferable that the plurality of electrodes be arranged so as to suppress an eddy current generated in the plurality of electrodes by a magnetic field generated during the supplying of power to the power-supply object.

In the power supply device configured as described above, it is preferable that each of the electrodes be comb-shaped.

In order to achieve the above-mentioned object, the method for detecting a foreign object according to the present invention is characterized in having a step for scanning and driving a plurality of electrodes arranged along a power supply surface, a step for acquiring a capacitance produced in each of the electrodes subjected to scanning and driving, a step for identifying a capacitance distribution in the power supply surface on the basis of the acquired capacitance produced in each of the electrodes, a step for determining the presence or absence of a foreign object on the power supply surface on the basis of the identified capacitance distribution, and a step for performing a predetermined process on the basis of the presence or absence of the foreign object on the power supply surface.

The power supply device of the present invention is provided with a plurality of electrodes, identifies a capacitance distribution in a power supply surface on the basis of capacitance produced in each of the electrodes, and performs a predetermined process upon detecting the presence of a foreign object on the power supply surface on the basis of the distribution. Therefore, it is possible to detect with high accuracy the presence of a foreign object by using solely the power supply device, without needing to provide the power-supply object with an electrode.

The method for detecting a foreign object according to the present invention comprises scanning a plurality of electrodes arranged along a power supply surface, acquiring the capacitance produced in each of the electrodes subjected to scanning and driving, and identifying a capacitance distribution in the power supply surface on the basis of the acquired capacitance produced in each of the electrodes. The method further comprises determining the presence or absence of a foreign object on the power supply surface on the basis of the capacitance distribution and performing a predetermined process on the basis of the presence or absence of a foreign object on the power supply surface. Therefore, it is possible to detect with high accuracy the presence of a foreign object by using solely the power supply device, without needing to provide the power-supply object with an electrode.

### DESCRIPTION OF THE DRAWINGS

FIG. 1 is a diagram illustrating the configuration of a contactless power supply system.

FIG. 2 is a drawing illustrating a first example of the pattern and arrangement of electrodes.

FIG. 3 is a drawing illustrating a second example of the pattern and arrangement of electrodes.

FIG. 4 is a drawing illustrating a third example of the pattern and arrangement of electrodes in the X direction.

FIG. 5 is a drawing illustrating the third example of the pattern and arrangement of electrodes in the Y direction.

FIG. 6 is a flowchart illustrating the flow of a process performed by a control unit of the power supply device according to a first embodiment.

FIG. 7 is a flowchart illustrating the flow of the process performed by the control unit of the power supply device according to a second embodiment.

FIG. 8 is a block diagram illustrating the configuration of the power supply device according to a third embodiment.

FIG. 9 is a flowchart illustrating the flow of the process performed by the control unit of the power supply device according to the third embodiment.

### DESCRIPTION OF THE PREFERRED EMBODIMENTS

### First Embodiment

A contactless power supply system provided with the power supply device of the present invention will be described hereinafter with reference to the drawings. The power supply device and the power-receiving device provided to the contactless power supply system in the present and subsequent embodiments are shown as examples of a power supply device and a power-receiving device in order to embody the technical idea of the present invention. The present invention is not intended to be limited to these specific power supply devices and power-receiving devices, and can be equally applied to power supply devices and power-receiving devices of other embodiments included in the scope of the claims.

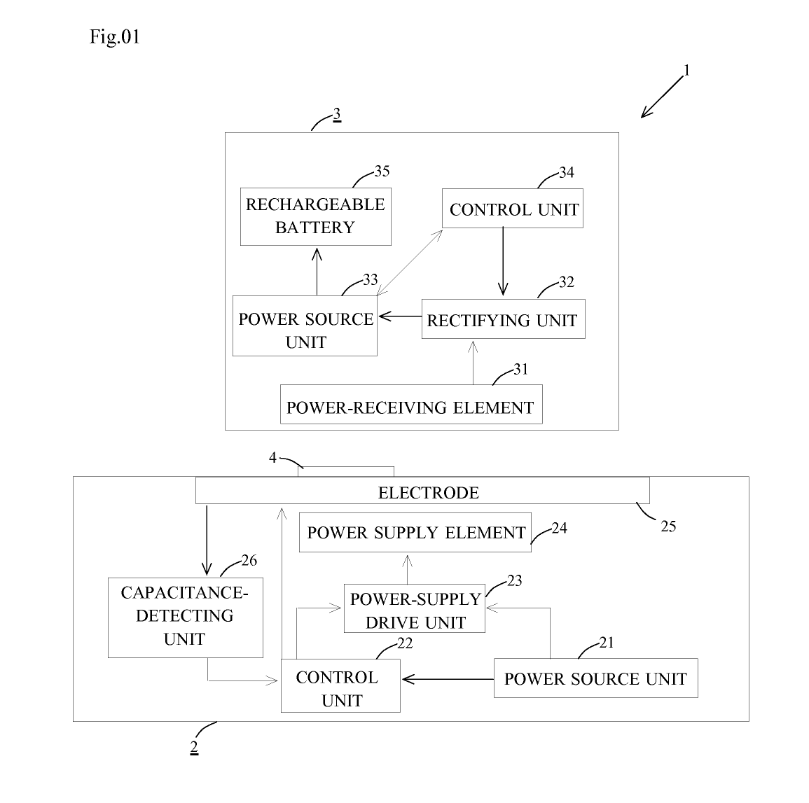

FIG. 1 is a diagram illustrating the configuration of a contactless power supply system. The contactless power supply system 1 is provided with a power supply device 2 and a power-receiving device 3. The power supply device 2 is provided with a power source unit 21, a control unit 22, a power-supply drive unit 23, a power supply element 24, an electrode 25, and a capacitance-detecting unit 26. The power source unit 21 is supplied with alternating-current (AC) power from a commercial power source (not shown). The power source unit 21 supplies electric power to the control unit 22 and the power-supply drive unit 23.

The control unit 22 is a control means for controlling the entire power supply device 2. The control unit 22 determines the presence or absence of an extraneous object on a power supply surface 2a and performs a predetermined process (the details of which are described later). The power-supply drive unit 23 supplies AC power to the power supply element 24.

When AC power is supplied to the power supply element 24, an AC current flows to the power supply element 24, and an alternating magnetic field is produced perpendicularly to the power supply surface 2a. An induced current is excited by the alternating magnetic field in a power-receiving element 31 placed close to the power supply element 24, and electric power is transmitted.

The material properties and shape of the power supply element 24 in the present and subsequent embodiments are not particularly limited; for example, it is possible to use a coil module shaped as a vortex that moves counterclockwise toward the center of an eddy as viewed from above. The power supply element 24 may comprise a plurality of power supply elements arranged in a matrix shape along the power supply surface 2a, or may comprise a single power supply element (moving coil) configured so as to be able to move along the power supply surface 2a.

The moving coil moves to the position on the power supply surface 2a at which a power-supply object is placed, and supplies electric power. The method for detecting the position of the power-supply object is not particularly limited; for example, the presence of a power-supply object can be detected by a shift in a resonant frequency as performed in the past.

A plurality of electrodes 25 is arranged on the power supply surface 2a. ITO films and other films widely used in electrostatic touch panels and the like are used as the electrodes 25 to make it possible to prevent the power supply efficiency from decreasing due to an increase in the physical distance between the power supply element 24 and the power-receiving element 31. The electrodes 25 in the present embodiment are arranged on the power supply surface 2a, i.e., on the upper side of the power supply element 24, and are positioned between the power supply element 24 and the power-receiving element 31. When an alternating magnetic field is produced from the power supply element 24 perpendicularly to the power supply surface 2a as described above, there is concern that Joule heat may be generated by an eddy current in the electrodes 25 depending on the shape and arrangement of the electrodes 25, and that the electrodes 25 may become abnormally heated.

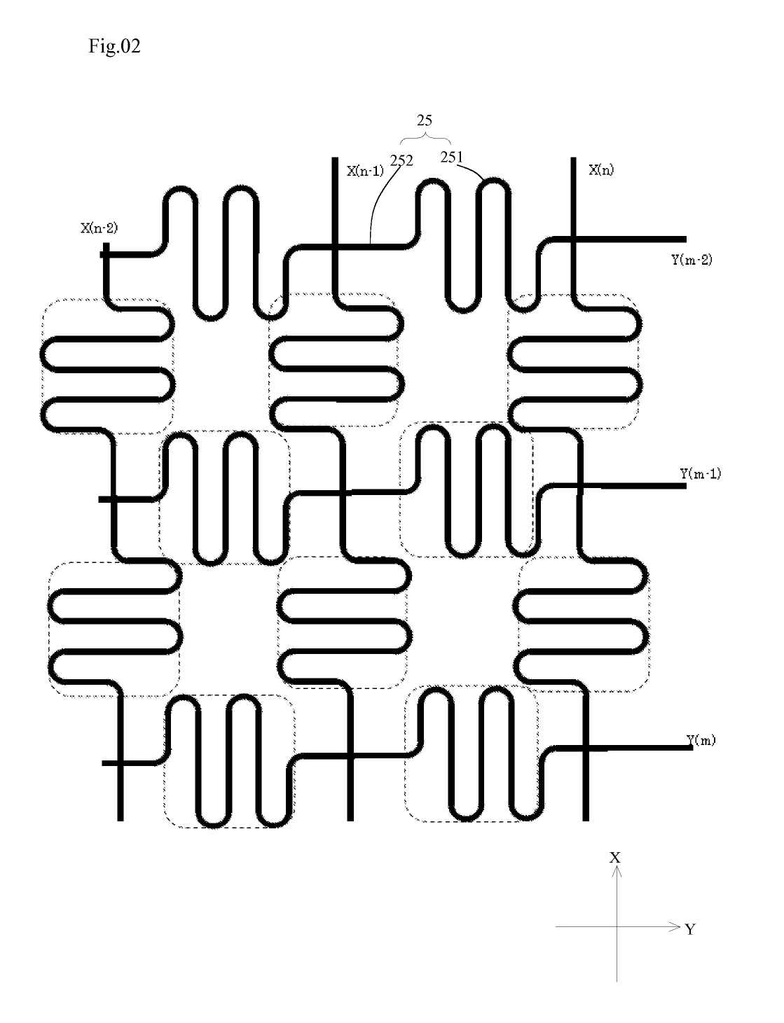

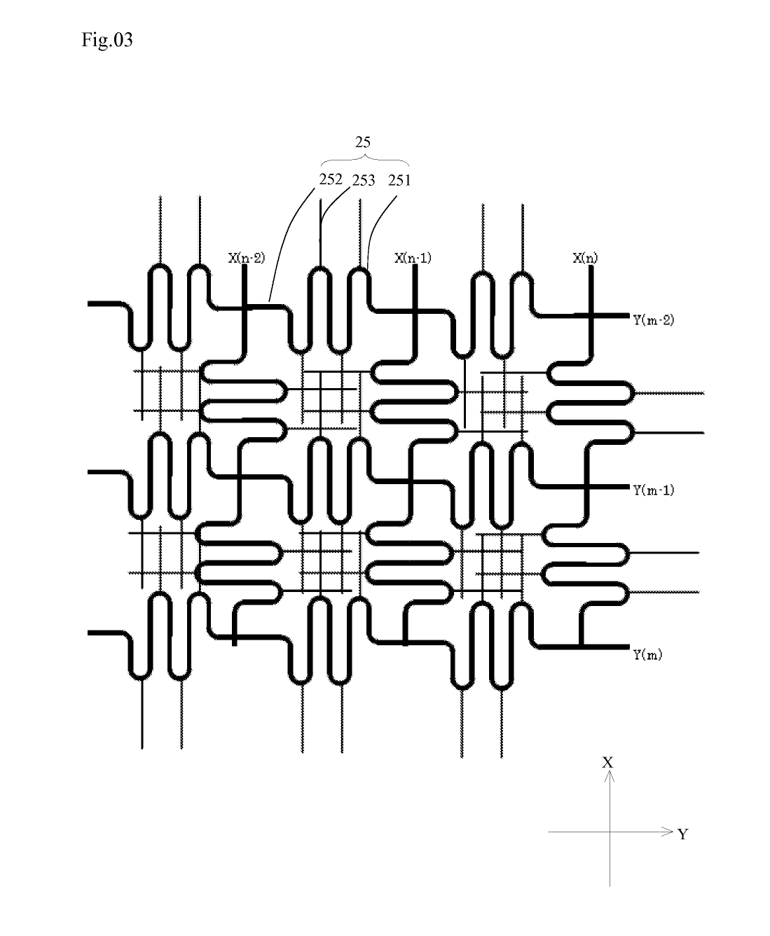

In view of this, the electrodes 25 in the present embodiment are arranged so as to suppress the generation of an eddy current caused by the alternating magnetic field produced from the power supply element 24. Specifically, the spaces between the electrodes 25 are enlarged, and the electrodes 25 are reduced in size and arranged in rows in the X direction and the Y direction (vertical and horizontal directions of the power supply surface). For example, the electrodes 25 obtained by linking ridge-shaped electrode units 251 together using straight electrode units 252 as shown in FIG. 2 are arranged in a two-layered structure in the X direction and the Y direction (specifically, the electrodes extending in the X direction and the electrodes extending in the Y direction are not connected to each other in a plane; the same is true in FIG. 3), and the straight electrode units 252 of the electrodes 25 extending in the X direction and the straight electrode units 252 of the electrodes 25 extending in the Y direction are arranged so as to overlap one on top of the other. The capacitance-detecting unit 26 thereby detects the capacitance primarily on the basis of the capacitance in the dotted-line portion shown in FIG. 2.

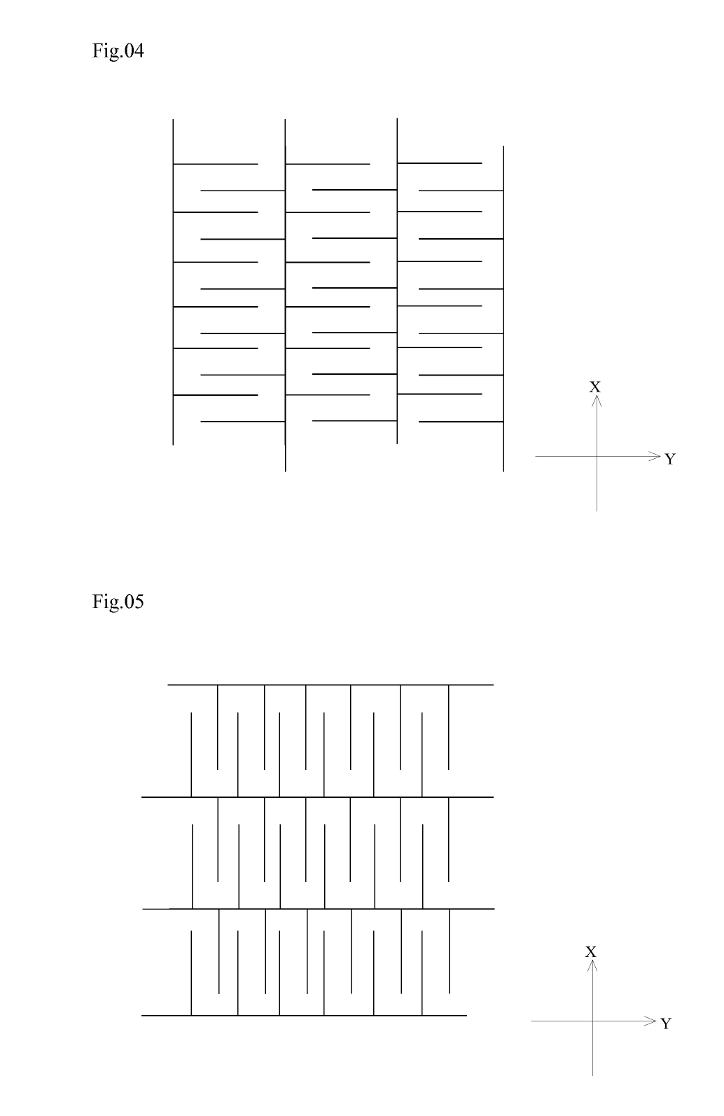

Needle-shaped electrode units 253 one end of which is open from the ridge-shaped electrode units 251 may be provided as shown in FIG. 3. This is because generation of an eddy current is suppressed in the needle-shaped electrode units 253. This makes it possible to increase the proportion (coverage ratio) of the area occupied by the electrodes 25 on the power supply surface 2a while suppressing the generation of eddy currents. Pectinate electrode units 25 may also be used, as shown in FIG. 4. In particular, the pectinate electrodes 25 shown in FIG. 4 suppress the generation of eddy currents, and the coverage ratio relative to the power supply surface 2a in the case of a two-layered structure is higher in comparison with other shapes. Therefore, the electric field shielding effect is enhanced, and long-distance radiation of electromagnetic waves by an alternating electric field during transmission of electric power by high-output electromagnetic induction can be suppressed. FIG. 4 illustrates electrodes 25 arranged in a row in the X direction, the arrangement being a two-layered structure with the electrodes 25 (refer to FIG. 5) arranged in a sequence in the Y direction in the same manner as in FIGS. 2 and 3.

The capacitance-detecting unit 26 is electrically connected to the electrodes 25, and the capacitance-detecting unit 26 detects the capacitance produced between each of the electrodes 25 and a finger or an extraneous object (the “capacitance produced between each of the electrodes 25 and a finger or an extraneous object” is also referred to as the “capacitance produced in each of the electrodes 25” below in the specification and the claims) and supplies the result of detection to the control unit 22. For example, in FIG. 2, electrodes 25 X(1) through X(n) are arranged in a row in the X direction, and electrodes 25 Y(1) through Y(m) are arranged in a row in the Y direction, with the capacitance-detecting unit 26 detecting the capacitance in each line. The control unit 22 identifies the capacitance distribution on the power supply surface 2a on the basis of information indicating the capacitance produced in each of the electrodes 25 as acquired from the capacitance-detecting unit 26, and determines the presence or absence of an extraneous object on the power supply surface 2a on the basis of the capacitance distribution.

A comparison between cases in which an extraneous object is present and not present on the power supply surface 2a indicates that the capacitance of the electrodes 25 at the position of an extraneous object 4 when the extraneous object 4 is on the power supply surface 2a as shown in FIG. 1 is greater than the capacitance of the electrodes 25 when the extraneous object 4 is absent. Therefore, the control unit 22 identifies the capacitance distribution of each of the electrodes 25 as detected by the capacitance-detecting unit 26, and determines the presence of an extraneous object if there is a portion in which the capacitance exceeds a predetermined value. Alternatively, the presence of an extraneous object is determined in the case of an area or size sufficient to provide a range in which the capacitance exceeds a predetermined value (for example, the area or size of a coin).

The power-receiving device 3 is provided with a power-receiving element 31, a rectifying unit 32, a power source unit 33, a control unit 34, and a rechargeable battery 35. The power-receiving element 31 receives electric power transmitted from the power-supply element 24 as described above. The AC power received by the power-receiving element 31 is supplied to the rectifying unit 32. The rectifying unit 32 is configured from, for example, a diode or a capacitor, and converts the AC power supplied from the power-receiving element 31 into direct-current (DC) power.

The electric power that was converted to direct current by the rectifying unit 32 is supplied to the power source unit 33. The control unit 34 is a control means for controlling the entire power-receiving device 3, and the control unit 34 controls the conversion by the rectifying unit 32 of the AC power received by the power-receiving unit 31 into DC power, as well as the accumulation of charge in the rechargeable battery 35 by the power source unit 33.

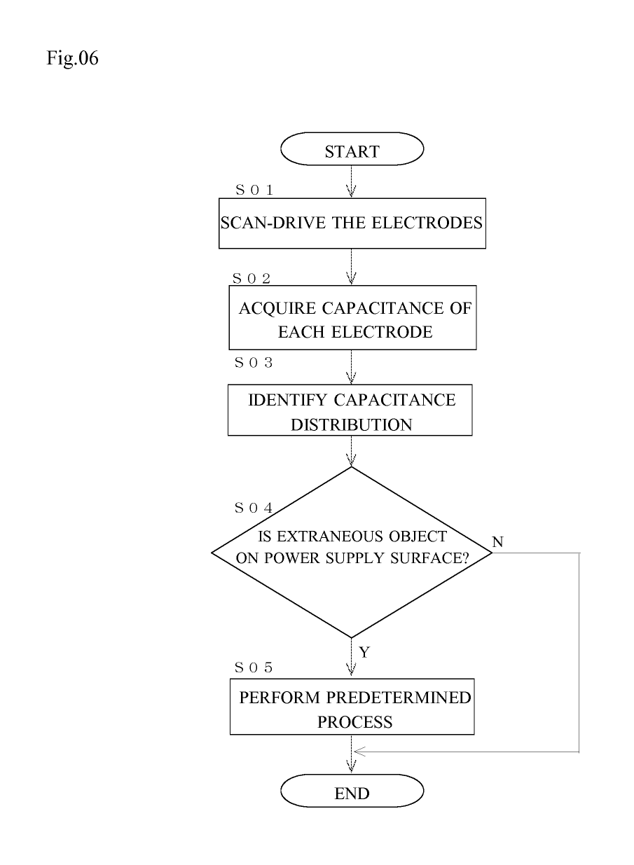

The process relating to the detection of an extraneous object as performed by the control unit 22 of the power supply device 2 is described below with reference to FIG. 6. FIG. 6 is a flowchart illustrating the flow of the process performed by the control unit 22 of the power supply device 2.

In step S01, the control unit 22 traversely scan-drives each of the electrodes 25.

The capacitance-detecting unit 26 uses traverse scanning and driving to detect the capacitance produced in each of the electrodes 25. In step S02, the control unit 22 acquires information indicating the capacitance produced in each of the electrodes 25 as detected by the capacitance-detecting unit 26. In step S03, the control unit identifies the capacitance distribution on the power supply surface 2a on the basis of the information indicating the capacitance produced in each of the electrodes 25 as acquired in step S02. For example, it can be seen with reference to FIG. 2 that in a case in which the capacitance of the electrode 25 X(n−1) and the capacitance of the electrode 25 Y(m−1) each exceed a predetermined value, the capacitance in the middle region of FIG. 2, which lies the vicinity of the intersection between the two electrode lines in the capacitance distribution, is greater than that in other regions.

In step S04, the control unit 22 determines whether or not there is an extraneous object on the power supply surface 2a. According to the example described above, the middle region of FIG. 2 has an area or size comparable to the size of an extraneous object and has a capacitance greater than that in the other regions. Therefore, the control unit 22 determines that there is an extraneous object in the middle region. The control unit 22 determines that there is no extraneous object on the power supply surface 2a in cases in which the capacitance in a region exceeds a predetermined value in the capacitance distribution but the region does not have an area or size comparable to the size of an extraneous object, or in cases in which no region has a capacitance that exceeds the predetermined value.

The process continues to step S05 if an extraneous object is present on the power supply surface 2a (step S04 Y), and the process pertaining to the detection of an extraneous object ends if there is no extraneous object on the power supply surface 2a (step S04 N). In step S05, the control unit 22 performs a predetermined process for preventing a decrease in power supply efficiency and a danger based on the presence of an extraneous object. The predetermined process of the present embodiment comprises stopping the supply of power to a power-supply object if the object is supplied with power. Specifically, a procedure is performed in which the power-supply drive unit 23 is controlled so that the AC power supplied from the power source unit 21 is not supplied any longer to the power supply element 24.

The traverse scanning and driving carried out by the control unit 22 (the process in step S01) may be performed at regular intervals or at irregular intervals.

According to the present embodiment, the plurality of electrodes is arranged in the X direction and the Y direction, the electrodes are subjected to traverse scanning and driving, and the capacitance produced in each of the electrodes is detected by the capacitance-detecting unit. The control unit identifies the capacitance distribution on the power supply surface on the basis of the capacitance produced in each of the electrodes, determines the presence or absence of an extraneous object on the power supply surface on the basis of the distribution, and performs a predetermined process if an extraneous object is present. Therefore, it is possible to detect with high accuracy the presence of a foreign object by using solely the power supply device without the need to provide the power-supply object with an electrode.

Because the predetermined process comprises stopping the supply of power to the power-supply object, it is possible to prevent fires and other events caused by abnormal heating of an extraneous object before these events happen.

Because the electrodes are shaped and arranged so as to suppress the generation of eddy currents by the alternating magnetic field generated during the supply of power to the power-supply object, it is possible to suppress the abnormal heating of the electrodes and the decrease in the power supply efficiency.

### Second Embodiment

In the first embodiment, the predetermined process was performed in a case in which there was an extraneous object on the power supply surface 2a, but the possibility that an eddy current could be generated in an extraneous object such that the extraneous object would become abnormally heated is low in a case in which the position of the extraneous object is at a distance from the position of a power-supply object. Therefore, the object of the present embodiment is that the predetermined process for preventing a decrease in the power supply efficiency and a danger based on the presence of an extraneous object on the power supply surface 2a is performed only if the extraneous object is positioned in the vicinity of the power-receiving device 3.

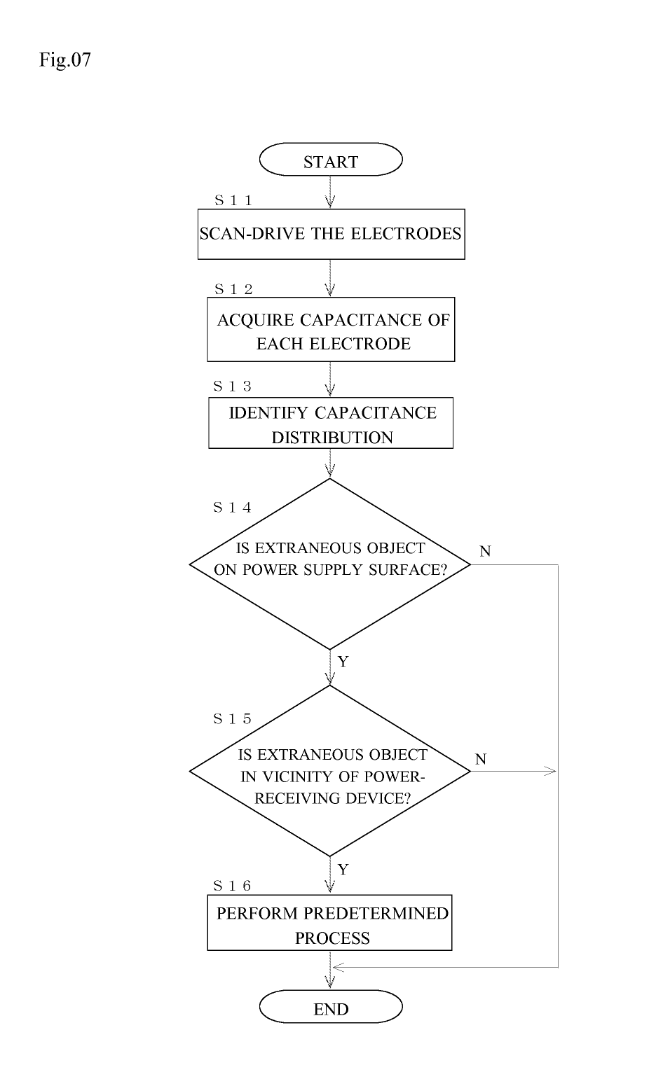

FIG. 7 is a flowchart illustrating the flow of the process performed by the control unit 22 of the power supply device 2 of the present embodiment. Steps S11-S14 and S16 in FIG. 7 are the same as steps S01-S04 and S05 in FIG. 6, and therefore the descriptions of these steps are omitted.

In step S15, the control unit 22 determines whether or not an extraneous object is positioned in the vicinity of the power-receiving device 3. The process continues to step S16 if an extraneous object is positioned in the vicinity of the power-receiving device 3 (step S15 Y), and the process pertaining to the detection of an extraneous object ends if there is no extraneous object in the vicinity of the power-receiving device 3 (step 15 N).

The positions of the power-receiving device 3 and the extraneous object can be identified from the capacitance distribution on the power supply surface 2a as described above. For example, in a case in which there are two or more regions in which the capacitance exceeds a predetermined value in the capacitance distribution, the region having a size comparable to that of the power-receiving device 3 is identified as the region in which the power-receiving device 3 is placed, and the region having a size smaller than that of the power-receiving device 3 is identified as a region in which the extraneous object is present. Then, the supply of power is stopped if the extraneous object is in a position where the positional relation is such that the object would be strongly affected by the alternating magnetic field generated during the supplying of power to the power-receiving device 3, but the supply of power is not stopped if the extraneous object is in a position where the effect would be small.

The present embodiment provides the same result as in the first embodiment. Additionally, the supply of power is not stopped in cases in which there is little concern about abnormal heating or reduced power supply efficiency, even when there is an extraneous object on the power supply surface.

### Third Embodiment

In the first and second embodiments, the predetermined process involved stopping the supply of power, but the predetermined process is not limited to this option alone and may be a process for preventing a decrease in the power supply efficiency and a danger based on the presence of an extraneous object as described above. Therefore, in the present embodiment, a warning about the presence of an extraneous object is made to a user to prompt the removal of the extraneous object.

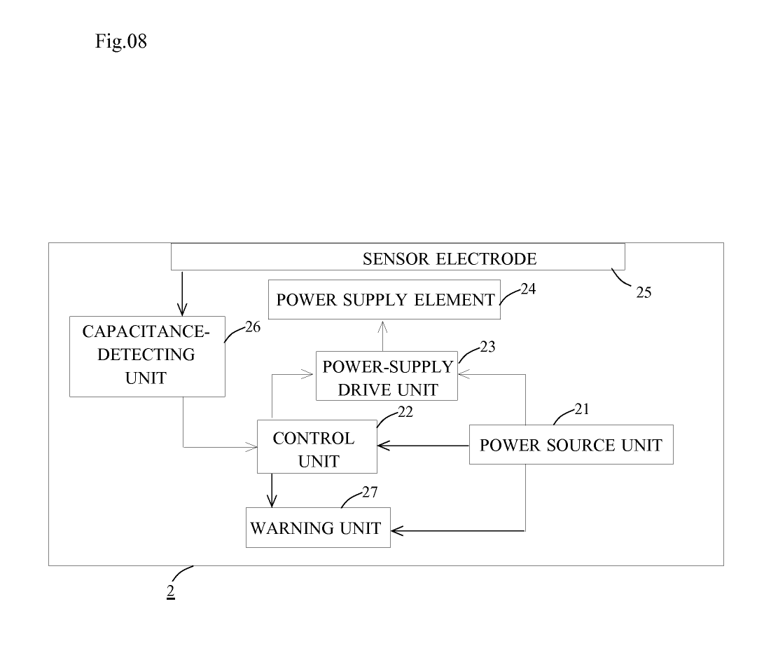

For example, the power supply device 2 of the present embodiment can be provided with, in addition to the configuration described above, a warning unit 27 as shown in FIG. 8. The warning unit 27 is exemplified by a display screen for displaying that there is an extraneous object on the power supply surface 2a, a speaker for providing voice guidance, an LED that is red, yellow, or another warning color, and a vibrating means (having vibration functionality) for causing the entire power supply device 2 to vibrate. By providing a warning via the warning unit 27 that there is an extraneous object on the power supply surface 2a, it is possible to prompt the user to remove the extraneous object from the power supply surface 2a.

The warning to prompt the removal of the extraneous object may be performed in conjunction with the process for stopping the supply of power according to the first and second embodiments. Particularly in the second embodiment, it is preferable to issue a warning to prompt the removal of the extraneous object in cases in which it is determined in step S15 that the extraneous object 4 is not positioned in the vicinity of the power-receiving device 3 (step S15 N). This makes it possible to prevent the extraneous object from becoming abnormally heated and to prevent the power supply efficiency from decreasing during a subsequent power supply.

According to the present embodiment, the predetermined process in a case in which there is an extraneous object on the power supply surface comprises issuing a warning via the warning unit that there is an extraneous object on the power supply surface. This makes it possible to prompt the user to remove the extraneous object from the power supply surface.

### Fourth Embodiment

In the first through third embodiments, the traverse scanning and driving were performed by the control unit 22 at regular or irregular intervals, but the scanning and driving may also be performed by the control unit 22 in a case in which a predetermined condition is fulfilled. The term “a predetermined condition” refers to a case in which it is necessary to determine whether or not there is an extraneous object on the power supply surface 2a; for example, a case in which it is detected that a power-receiving device 3 is approaching the power supply surface 2a.

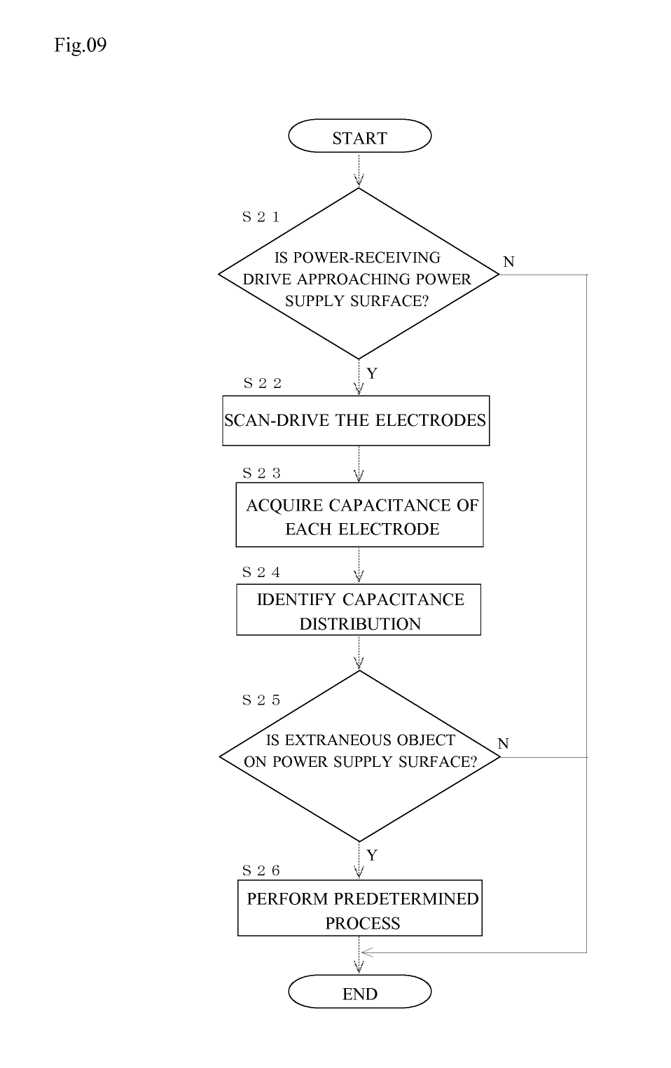

FIG. 9 is a flowchart illustrating the flow of the process performed by the control unit 22 of the power supply device 2 of the present embodiment. Steps S22-S26 in FIG. 9 are the same as steps S01-S05 in FIG. 6, and therefore the descriptions of these steps are omitted.

In step S21, the control unit 22 determines whether or not a power-receiving device 3 is approaching the power supply surface 2a. When a power-receiving device 3 approaches the power supply surface 2a, there is a change in the capacitance of the electrode 25 that corresponds to the position of the approach. It is therefore possible to determine whether or not a power-receiving device 3 is approaching the power supply surface 2a on the basis of a change in capacitance of at least one of the electrodes 25.

The scanning and driving in step S22 are performed in order to identify the capacitance distribution, but the change in capacitance can be detected by the capacitance-detecting unit 26 without subjecting each of the electrodes 25 to traverse scanning and driving.

The process continues to step S22 in a case in which information indicating a change in capacitance of at least one of the electrodes 25 is acquired (step S21 Y), and the process pertaining to the detection of an extraneous object ends if information indicating a change in capacitance of the electrodes 25 is not acquired (step S21 N).

According to the present embodiment, traverse scanning and driving are performed by the control unit 22 in a case in which the predetermined condition is fulfilled.

What is claimed is:

1. A power supply device, provided with:
a power supply surface on which a power-supply object is placed;
a plurality of electrodes arranged along the power supply surface;
a capacitance-detecting unit for detecting the capacitance produced in each of the electrodes; and
a control unit for scanning and driving the plurality of electrodes, identifying a capacitance distribution on the power supply surface on the basis of the capacitance produced in each of the electrodes as detected by the capacitance-detecting unit, determining the presence or absence of a foreign object on the power supply surface on the basis of the capacitance distribution, and performing a predetermined process.

2. The power supply device of claim 1, wherein the control unit determines the presence or absence of a foreign object on the power supply surface on the basis of the area and shape of a portion in which the value of the capacitance exceeds a predetermined value in the capacitance distribution for the power supply surface.

3. The power supply device of claim 1, wherein the control unit stops the supply of power to the power-supply object, as the predetermined process, in a case in which there is a foreign object on the power supply surface.

4. The power supply device of claim 1, wherein the control unit identifies a position of a foreign object when the foreign object is on the power supply surface, and stops the supply of power to the power-supply object, as the predetermined process, in a case in which the foreign object is positioned in the vicinity of the power-supply object.

5. The power supply device of claim 1, wherein the control unit issues a warning about the presence of a foreign object, as the predetermined process, in a case in which the foreign object is on the power supply surface.

6. The power supply device of claim 1, wherein the control unit scans and drives the plurality of electrodes on the basis of information indicating a change in capacitance of at least one of the electrodes and identifies the capacitance distribution on the power supply surface.

7. The power supply device of claim 1, wherein the plurality of electrodes are arranged so as to suppress an eddy current generated in the plurality of electrodes by a magnetic field generated during the supplying of power to the power-supply object.

8. The power supply device of claim 7, wherein each of the electrodes is comb-shaped.

9. A method for detecting a foreign object, having:
a step for scanning and driving a plurality of electrodes arranged along a power supply surface;
a step for acquiring a capacitance produced in each of the electrodes subjected to scanning and driving;
a step for identifying a capacitance distribution on the power supply surface on the basis of the acquired capacitance produced in each of the electrodes;
a step for determining the presence or absence of a foreign object on the power supply surface on the basis of the identified capacitance distribution; and
a step for performing a predetermined process on the basis of the presence or absence of the foreign object on the power supply surface.
